(19) United States
(12) Patent Application Publication
(10) Pub. No.: US 2019/0227576 A1
(43) Pub. Date: Jul. 25, 2019

(54) SYSTEM AND METHOD FOR POSITION DETERMINATION FOR UNMANNED VEHICLES

(71) Applicant: Walmart Apollo, LLC, Bentonville, AR (US)

(72) Inventors: Donald R. High, Noel, MO (US); David C. Winkle, Bella Vista, AR (US); John J. O'Brien, Farmington, AR (US); Robert L. Cantrell, Herndon, VA (US); Todd D. Mattingly, Bentonville, AR (US)

(21) Appl. No.: 16/243,211

(22) Filed: Jan. 9, 2019

Related U.S. Application Data
(60) Provisional application No. 62/620,016, filed on Jan. 22, 2018.

(51) Int. Cl. G05D 1/12; G05D 1/10; G05D 1/00; G01C 21/20; B64C 39/02; G06Q 10/08

(52) U.S. Cl. CPC G05D 1/12; G05D 1/101; G05D 1/0094; B64C 2201/141; B64C 39/024; G06Q 10/08355; B64C 2201/128; G01C 21/206

(57) ABSTRACT

Sensory information is obtained at a drone (e.g., from sensors at the drone or deployed at other locations), and the sensory information defines the physical operating environment of the drone. The aerial drone is initially operated according to a current geographical location that is received. The sensory information is subsequently obtained, for example, from the sensors. An adjusted current geographical location of the aerial drone is selectively determined based upon an evaluation of the sensory information and a UWB beacon signal. The aerial drone is operated according to the adjusted current geographical location.

### CROSS-REFERENCE TO RELATED APPLICATION

This application claims the benefit of the following U.S. Provisional Application No. 62/620,016 filed Jan. 22, 2018, which is incorporated herein by reference in its entirety.

### TECHNICAL FIELD

These teachings relate to the operation of drones or other unmanned vehicles and, more specifically, to the accurate determination of the position of these vehicles.

### BACKGROUND

Aerial drones are used to perform a wide variety of functions. Some aerial drones are used to deliver products, for example, to the residences of consumers or businesses. Other aerial drones are used for surveillance purposes. Drones can be used for other functions as well.

The accurate navigation of a drone depends upon knowing the position of the drone. The location identifies where the drone is in relation to other physical features or obstacles, such as houses, buildings, trees, power lines, mountains, or roads. The location also identifies where the drone is with respect to the ultimate destination of the drone.

Some drones operate independently. That is, the drone independently navigates itself according to its known or believed position without the assistance of (or with minimal assistance from) external guidance sources or centers. When the position of the drone is not accurate, various types of problems can occur. For example, the drone may collide with various obstacles, and become destroyed or disabled. In other cases, since the position of the drone is not accurate, the drone can make inaccurate navigational decisions, which cause delivery of the cargo to be delayed (e.g., follow a longer flight path than needed).

### BRIEF DESCRIPTION OF THE DRAWINGS

The above needs are at least partially met through the provision of approaches that determine the accurate position of drones (or other unmanned vehicles), particularly when studied in conjunction with the drawings, wherein:

FIG. 1 comprises a diagram of a system as configured in accordance with various embodiments of these teachings;

FIG. 2 comprises a flowchart as configured in accordance with various embodiments of these teachings;

FIG. 3 comprises a diagram of a system as configured in accordance with various embodiments of these teachings.

### DETAILED DESCRIPTION

Generally speaking, an aerial drone verifies its current position using a UWB beacon signal and sensor information, (e.g., an image from a camera). Based upon this information, the current position may be adjusted to allow more accurate control and navigation of the drone.

In many of these embodiments, an aerial drone that is used in delivery of commercial products to customers through a populated flight path is provided. The drone includes a product storage bay, an electronic memory, a transceiver, a sensor, and a control circuit.

The product storage bay is configured to store one or more commercial products. The transceiver is configured to receive a UWB beacon signal from a ground station and a current geographical location of the aerial drone from, for example, a third-party location determination service such as a GPS service. The current geographical location is stored in the electronic memory of the drone.

The sensor is configured to obtain sensory information defining the physical operating environment of the drone. The control circuit is coupled to the transceiver and the sensor, and is configured to initially operate the aerial drone according to the current geographical location received from the transceiver. The control circuit is configured to subsequently obtain the sensory information from the sensor and selectively determine an adjusted current geographical location of the aerial drone based upon an evaluation of the sensory information and the UWB beacon signal. The control circuit is further configured to operate the aerial drone according to the adjusted current geographical location that has been determined.

In aspects, the UWB beacon signal includes a tag identifier of the ground station. In some examples, the sensory information is a visual image of a tag on the ground station (which the sensor detects), and the control circuit determines whether the tag identifier of the ground station (in the beacon signal) matches the tag in the image (obtained by the sensor).

In other examples, adjusting the operation comprises adjusting the flight path of the drone. In other aspects, the drone is configured to communicate with a ground controller, and control of the drone passes to the ground controller when the drone enters a localization bubble. In examples, the localization bubble corresponds to a warehouse, a distribution center, or a retail store. Other examples of localization bubbles are possible. In yet other aspects, the ground controller returns control to the drone when the drone exits the localization bubble.

In examples, the drone has an adjustable set of operating privileges. For example, the drone may be able to freely operate in some areas, but may not be able to freely operate in other areas. In other examples, the sensor is a camera. Other examples of sensors are possible.

In others of these embodiments, an approach for operating an aerial drone that is used for the delivery of commercial products to customers through a populated flight path is provided. One or more commercial products are stored in a product storage bay of the drone. A UWB beacon signal is received at an aerial drone from a ground station and a current geographical location of the aerial drone is also received from some entity.

Sensory information is obtained at the drone (e.g., from sensors at the drone or deployed at other locations), and the sensory information defines the physical operating environment of the drone. The aerial drone is initially operated according to the current geographical location received. The sensory information is subsequently obtained, for example, from the sensors.

An adjusted current geographical location of the aerial drone is selectively determined based upon an evaluation of the sensory information and the UWB beacon signal. The aerial drone is operated according to the adjusted current geographical location.

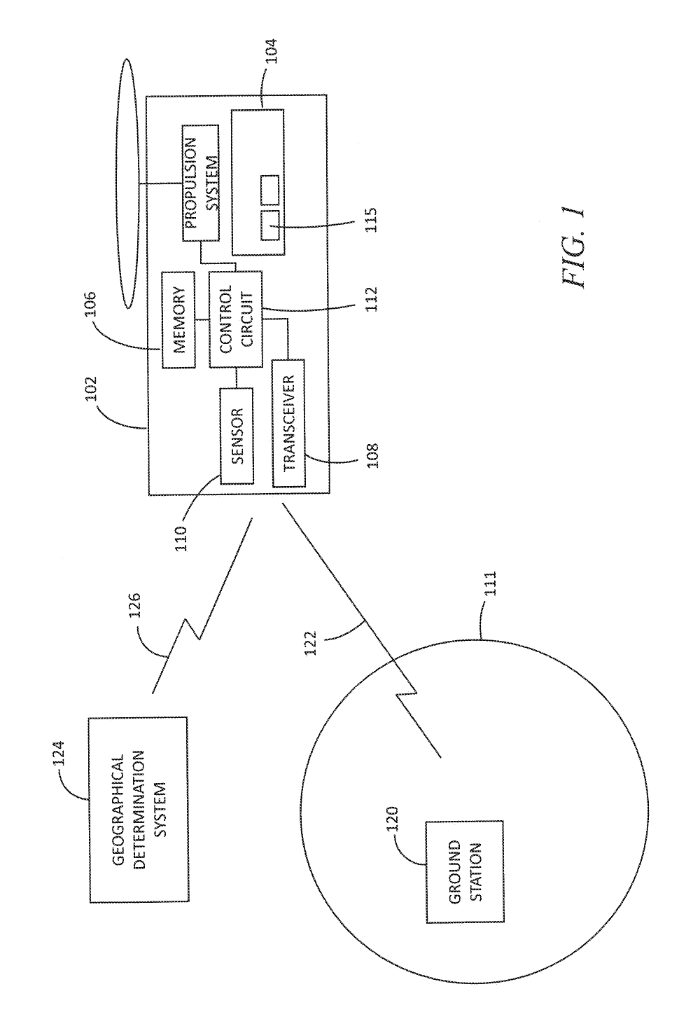

Referring now to FIG. 1, an aerial drone 102 that is used in delivery of commercial products to customers through a populated flight path is described. The drone 102 includes a product storage bay 104, an electronic memory 106, a transceiver 108, a sensor 110, and a control circuit 112. The drone 102 may also include a propulsion system 114.

The product storage bay 104 is any space or compartment (enclosed, unenclosed, or partially enclosed) in the drone 102 that configured to store one or more commercial products 115. The commercial products 115 may be any types of products and packaged in any packaging arrangement. The commercial products 115 may be delivered to homes, businesses, schools, warehouses, distribution centers, or any other type of destination.

The transceiver 108 is any type of device (e.g., any combination of hardware or software) that transmits or receives signals. The transceiver 108 may provide conversion functions as well.

The transceiver 108 is configured to receive a UWB beacon signal 122 from a ground station 120 and a current geographical location 126 of the aerial drone 120 from, for example, a geographical determination service or system 124 such as a GPS service. The current geographical location 126 is stored in the electronic memory 106 of the drone 102. The electronic memory 106 may be any type of memory storage device.

The sensor 110 is configured to obtain sensory information defining the physical operating environment of the drone. In examples, the sensor is a camera, scanner, radar unit, or lidar unit. Other examples of sensors are possible.

The control circuit 112 is coupled to the transceiver 108 and the sensor 110. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuits 112 may be configured (for example, by using corresponding programming stored in a memory as will be well understood by those skilled in the art) to carry out one or more of the steps, actions, and/or functions described herein.

The control circuit 112 configured to initially operate the aerial drone 102 according to the current geographical location 126 received from the transceiver 108. The current geographical location 126 may be transmitted to the aerial drone 102 from the geographical determination system 124. The geographical determination system 124, in examples, may be a GPS system or similar system that has obtained or determined the location (or general location) of the drone 102. The current geographical location 126 may be any type of coordinate information or combination of coordinate information (e.g., latitude, longitude, altitude, bearing, relative or absolute position within a city, state, county, or other geographic area to mention a few examples).

The control circuit 112 is configured to subsequently obtain the sensory information (e.g., camera images) from the sensor 110 and selectively determine an adjusted current geographical location of the aerial drone 102 based upon an evaluation of the sensory information and the UWB beacon signal 122.

The adjusted location uses the current geographical location as a base, and makes an adjustment from that value. For example, analysis of the images may indicate that the drone 102 is to the right or left of the presumed position. Consequently, an adjustment can be made.

In aspects, the UWB beacon signal includes a tag identifier of the ground station 120. In some examples, the sensory information is a visual image of a tag on the ground station 120 (which the sensor detects), and the control circuit 112 determines whether the tag identifier of the ground station 120 (in the beacon signal 122) matches the tag in the image (obtained by the sensor 110). In this example, various image processing techniques can be used to process the sensed information. The ground station 120 may include a transceiver, memory, and control circuit. In other examples, the UWB beacon signal 122 can be obtained by the drone and a distance and/or bearing of the signal can be determined.

As described herein, UWB communications technology (sometimes referred to as Pulse Radio) is an approach for transmitting and receiving signals in short-ranges, but uses a high-bandwidth of communication over a radio spectrum (>500 MHz). UWB does not interfere with conventional narrowband and carrier wave transmissions operating in the same frequency band. UWB is typically an antenna transmission where the transmitted bandwidth signal in some aspects exceeds the lesser of 500 MHz, or 20% of fractional bandwidth.

Because each pulse in a pulse-based UWB occupies an entire UWB bandwidth, it benefits from relative immunity from multipath fading, but not from inter-symbol interference (ISI). ISI is a form of distortion of a signal in which one symbol interferes with subsequent symbols. Multipath interference is a phenomenon in physics where waves interfere with each other, resulting in a phase shift.

UWB pulses are generated with definitive time modulation, allowing for the information received to be analyzed with the time the signal was dispatched. This enables a pulse-position or time modulation. The UWB signal is then modulated by encoding the polarity of the pulse and its amplitude, or by utilizing orthogonal pulses. Because of UWB's ability to integrate time modulation into the signal, time-of-flight can be determined and this assists in overcoming multipath propagation.

The control circuit 112 is further configured to operate the aerial drone 102 according to the adjusted current geographical location that has been determined. In examples, adjusting the operation comprises adjusting the flight path of the drone. In yet other examples, any combination of the speed, bearing, or altitude of the drone 102 may be adjusted.

In other aspects, the drone 102 is configured to communicate with a ground controller, and control of the drone 102 passes to the ground controller when the drone enters a localization bubble 111. In examples, the ground controller may be disposed at the ground station 122. In other examples, the ground controller may be disposed separately from the ground station 122. In aspects, the ground controller may be implemented as computer software executed at a control circuit.

In examples, the localization bubble 111 corresponds to a warehouse, a distribution center, or a retail store. Other examples of localization bubbles are possible. In aspects, the localization bubble 111 comprises a localization grid located indoors and/or outdoors where the grid defines the precise location of the drone 102 in (x,y,z) coordinates along with trajectory of the drone 102. Under this approach, the ground controller treats the drone 102 entering the bubble as a data point.

In yet other aspects, the ground controller returns control to the drone 102 when the drone 102 exits the localization bubble 111. For example, the ground controller may return control to the drone 102 or to some other controller.

In examples, the drone 102 has an adjustable set of operating privileges. For example, the drone 102 may be able to freely and independently operate in some areas, but may not be able to freely operate in other areas. These privileges may include the ability to take certain actions (e.g., perform take-offs or landings) without obtaining the permission of other entities.

The approaches described herein could employ trucks, distribution centers, stores and perhaps other fixed location sources (local ground stations) which would transmit their location using a low power transmitter (e.g., using UWB signals) so that drones in the vicinity could determine their general location. A UWB transceiver could be added to each of the local ground stations to provide alternate communications channels and also serve to locate the drone in the event of loss of primary location system. The UWB signals could act as a beacon for drones heading “home” after an event.

If the drone 102 is located in range of three such ground stations, it may be able to triangulate its position. Images of recognizable landmarks can be analyzed by the system to determine the location of the drone 102. The system could use beacon data from one or two ground stations along with image data from a drone 102 to determine the location of the drone 102 (e.g., using landmark recognition approaches). The system could use hybrid triangulation plus imaging, pre-process triangulation signals to narrow selection of what images to process.

This information may be used as a sanity check for the location of the drone 102. The drone may also use the information as a homing signal for the drone to follow and return to a “home” location.

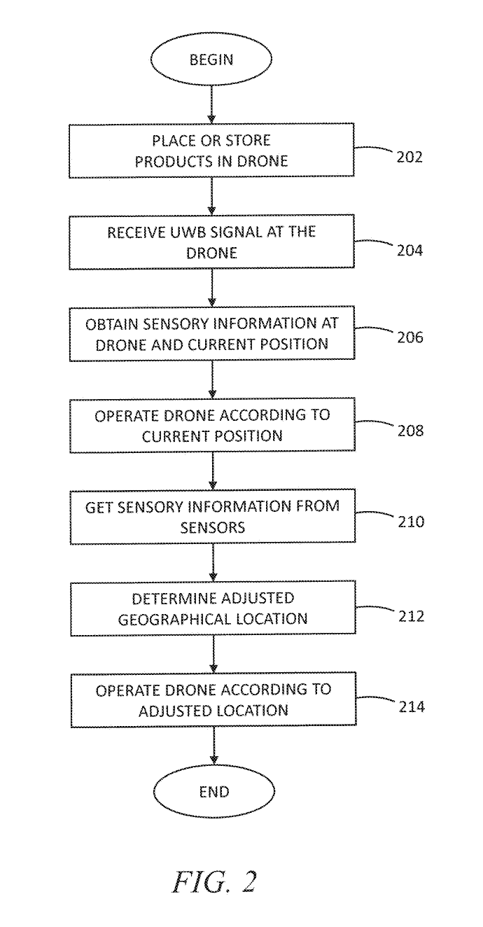

Referring now to FIG. 2, one example of an approach for operating an aerial drone that is used for the delivery of commercial products to customers through a populated flight path is described.

At step 202, one or more commercial products are stored in a product storage bay of the drone. The commercial products may be, for example, products that are to be delivered to homes, businesses, warehouses, retail stores, or distribution centers.

At step 204, a UWB beacon signal is received at an aerial drone from a ground station and a current geographical location of the aerial drone is also received from some entity. The other entity may be a third-party location determination service such as a GPS service. Other examples of third-party services are possible.

At step 206, sensory information is obtained at the drone (e.g., from sensors at the drone or deployed at other locations), and the sensory information defines the physical operating environment of the drone. In one example, the sensors obtain images of the drone's environment. In other examples, various types of signals (e.g., radar, UWB, or any other type of signal) may be sent from the drone, and a response signal received. Evaluation and analysis of these signals obtains a definition (e.g., identification) of the environment (e.g., the type of environment or the location of landmarks or obstacles in the environment to mention two examples).

At step 208, the aerial drone is initially operated according to the current geographical location received. The operation may include operating the propulsion and/or navigation system of the drone to reach a certain location. The altitude, speed, acceleration, deceleration, and bearing (to mention a few examples) may be controlled.

At step 210, the sensory information is subsequently obtained, for example, from the sensors. The sensory information may be processed, for example, translated into a digital format from an analog format.

At step 212, an adjusted current geographical location of the aerial drone is selectively determined based upon an evaluation of the sensory information and the UWB beacon signal. For example, if a drone is located in range of three UWB ground stations, it may be able to use triangulation approaches and determine its position. Images of recognizable landmarks (e.g., of tags on the transceivers of the ground stations) can also be analyzed by the system or the drone to determine, confirm, or fine-tune the location of the drone. The system could also use beacon data from one or two ground stations along with image data from a drone to determine the location of the drone (e.g., using landmark recognition approaches). The system could additionally use hybrid triangulation plus imaging approaches such as pre-processing triangulation signals to narrow selection of what images to process. Once a position is determined by any of these approaches (or combination of these approaches), any adjustments from the current position can be determined.

At step 214, the aerial drone is operated according to the adjusted current geographical location. The altitude, speed, acceleration, deceleration, and bearing (to mention a few examples) may be controlled and adjusted.

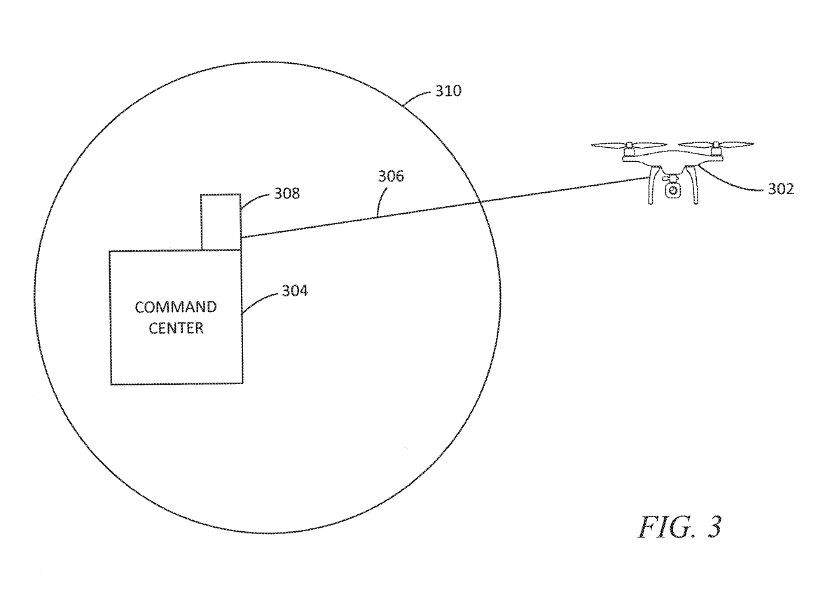

Referring now to FIG. 3, one example of an approach for navigating an unmanned vehicle is described. In this example, the unmanned vehicle 302 is an aerial drone. The aerial drone 302 informs a command center 304 that the drone 302 is in the area of the command center. The drone 302 includes a sensor such as a camera.

A UWB signal 306 is transmitted by a transceiver 308. The transceiver 308 is a device that can transmit and receive various types of signals. In this example, the transceiver can transmit UWB signals. However, the transceiver may also transmit and receive other types of signals either simultaneously or non-simultaneously with other types of signals. The aerial drone 302 detects the UWB signal 306.

The drone 302 communicates with the command center 304 via the transceiver 308. In these regards, further communications are exchanged. The drone 302 may ask the command center 304 whether the drone 302 is clear for landing, and the command center may respond. The drone 302 may also ask the command center 304 to reserve a landing pad for the drone 302, and the command center 304 may respond. The drone 302 may additionally ask the command center 304 for its location, and the command center 304 may respond. The drone 302 may ask the drone 302 whether it is or has been seen by the command center 304.

The drone 302 may also determine its location by viewing tags located at the command center 304 (or tags associated or nearby the transceiver). For example, the sensor may be a camera that obtains images of tags, signs, or other identifiers associated with the command center 304.

The drone 302 communicates with its sensor to obtain image-based information obtained by the sensor. In one example, the drone uses its image capturing sensor to confirm that a physical tag matches what the sensor's data tag has sent. For instance, if the transceiver 308 said it was device 11A, the drone 302 could confirm this information based evaluations of images of a physical tag at the transceiver 308. For example, a metal tag coupled to the transceiver 308 could indicate the transceiver as “11A.” In this case, the transmission from the transceiver 308 indicated that the transceiver 308 was device “11A” and the image obtained by the sensor at the drone 302 includes a tag printed with or including a marking of “11A,” then the drone 302 could confirm some aspects of its position. In aspects, the drone 302 could determine the strength of the UWB signal and together with the orientation of the “11A” image determine a location of the drone. The location, in one example, may be expressed as geographic coordinates.

In one example of the operation of the system of FIG. 3, the drone 302 crosses the boundary of a localization bubble 310. In aspects, the localization bubble 310 comprises a localization grid located indoors and/or outdoors where the grid defines the precise location of the drone 302 in (x,y,z) coordinates along with trajectory of the drone 302.

Once the drone gets within the localization bubble, then the drone 302 becomes a data point to the command center 304. A handshake is made between the drone 302 and the command center 304. The command center 304 takes over and guides the drone 302 into the bubble 310. The drone 302 can continue to update its position as described. The position may be communicated to the command center 304, which can use this position to navigate the drone 302 (e.g., by transmitting control signals to the drone 302).

The command center 304 can also guide the drone out of the bubble 310. For example, the command center 304 can instruct another entity to receive and take control of the drone 302 outside of the bubble 310. In other examples, the drone 302 can resume independent control of its own actions once it leaves the localization bubble 310.

This system of FIG. 3 can allow for third-party assets to interact with the system with different privileges. If a particular asset of a particular owner is functioning within this system, it may have more privileges than other, third-party assets.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An aerial drone for use in delivery of commercial products to customers through a populated flight path, comprising:
a product storage bay that is configured to store one or more commercial products;
an electronic memory;
a transceiver, the transceiver configured to receive a UWB beacon signal from a ground station and a current geographical location of the aerial drone, the current geographical location being stored in the electronic memory;
a sensor, the sensor configured to obtain sensory information defining the physical operating environment of the drone;
a control circuit coupled to the transceiver and the sensor, the control circuit being configured to:
initially operate the aerial drone according to the current geographical location received from the transceiver;
subsequently obtain the sensory information from the sensor;
selectively determine an adjusted current geographical location of the aerial drone based upon an evaluation of the sensory information and the UWB beacon signal;
operate the aerial drone according to the adjusted current geographical location.

2. The drone of claim 1, wherein the UWB beacon signal includes a tag identifier of the ground station, and wherein the sensory information is an image of a tag on the ground station, and wherein the control circuit determines whether the tag identifier of the ground station matches the tag in the image.

3. The drone of claim 1, wherein adjusting the operation comprises adjusting the flight path of the drone.

4. The drone of claim 1, wherein the drone is configured to communicate with a ground controller and wherein control of the drone passes to the ground controller when the drone enters a localization bubble.

5. The drone of claim 4, wherein the localization bubble corresponds to a warehouse, a distribution center, or a retail store.

6. The drone of claim 4, wherein the ground controller returns control to the drone when the drone exits the localization bubble.

7. The drone of claim 1, wherein the drone has an adjustable set of operating privileges.

8. The drone of claim 1, wherein the sensor is a camera.

9. A method of operating an aerial drone that is used for the delivery of commercial products to customers through a populated flight path, the method comprising:
storing one or more commercial products in a product storage bay of the drone;
receiving a UWB beacon signal at an aerial drone from a ground station and receiving a current geographical location of the aerial drone;
obtaining sensory information at the drone, the sensory information defining the physical operating environment of the drone;
initially operating the aerial drone according to the current geographical location;
selectively determining an adjusted current geographical location of the aerial drone based upon an evaluation of the sensory information and the UWB beacon signal;
operating the aerial drone according to the adjusted current geographical location.

10. The method of claim 9, wherein the UWB beacon signal includes a tag identifier of the ground station, and wherein the sensory information is an image of tag on the ground station, and further comprising determining whether the tag identifier of the ground station matches the tag in the image.

11. The method of claim 9, wherein adjusting the operation comprises adjusting the flight path of the drone.

12. The method of claim 9, wherein the drone is configured to communicate with a ground controller and wherein control of the drone passes to the ground controller when the drone enters a localization bubble.

13. The method of claim 12, wherein the localization bubble corresponds to a warehouse, a distribution center, or a retail store.

14. The method of claim 12, wherein the ground controller returns control to the drone when the drone exits the localization bubble.

15. The method of claim 9, wherein the drone has an adjustable set of operating privileges.

16. The method of claim 9, wherein the sensor is a camera.
